(19) United States
(12) Patent Application Publication
(10) Pub. No.: US 2018/0080646 A1
(43) Pub. Date: Mar. 22, 2018

(54) METHOD FOR PROCESSING A LIQUID MEDIUM AND PROCESSING PLANT

(71) Applicant: Siemens Aktiengesellschaft, Munich (DE)

(72) Inventors: Raul Roman Hernandez, Offenbach am Main (DE); Manfred Baldauf, Erlangen (DE); Markus Ziegmann, Baiersdorf (DE)

(73) Assignee: Siemens Aktiengesellschaft, Munich (DE)

(21) Appl. No.: 15/561,759

(22) PCT Filed: Mar. 31, 2016
(86) PCT No.: PCT/EP2016/057095

§ 371 Date: Sep. 26, 2017

(30) Foreign Application Priority Data
Apr. 10, 2015 (DE) 10 2015 206 484.0

(51) Int. Cl. F22B 37/26; F22B 37/48; F22B 37/50; F01K 7/16; F01K 21/06; C02F 1/12; C02F 1/20; B01D 1/20; B01D 5/00; B01D 61/48; C02F 1/469

(52) U.S. Cl. CPC F22B 37/265; B01D 2311/2673; F22B 37/50; F01K 7/16; F01K 21/06; C02F 1/12; C02F 1/20; B01D 1/20; B01D 5/0075; B01D 5/006; B01D 5/0069; B01D 61/48; C02F 1/4695; B01D 2311/2653; F22B 37/486

(57) ABSTRACT

A method for processing a liquid medium, wherein the medium to be processed is conducted through a liquid circuit and the medium to be processed is heated up in the liquid circuit with the aid of a heat exchanger. A liquid-vapor separation process is carried out in a separating device, and a liquid obtained in the liquid-vapor separation process is conducted into the heat exchanger as a heating medium.

### CROSS REFERENCE TO RELATED APPLICATIONS

This application is the US National Stage of International Application No. PCT/EP2016/057095 filed Mar. 31, 2016, and claims the benefit thereof. The International Application claims the benefit of German Application No. DE 102015206484.0 filed Apr. 10, 2015. All of the applications are incorporated by reference herein in their entirety.

### FIELD OF INVENTION

The invention relates to a method for processing a liquid medium, in which the medium to be processed is conducted through a liquid circuit and the medium to be processed is heated in the liquid circuit with the aid of a heat exchanger. The invention also relates to a processing plant for processing a liquid medium, which plant comprises a liquid circuit with a heat exchanger for heating the medium to be processed.

### BACKGROUND OF INVENTION

In numerous technical fields a liquid medium has to be subjected to processing before its first use and/or before its reuse as a process liquid. In this case, for example substances can be removed from the medium and/or other substances can be introduced into the medium in order to change certain parameters of the liquid medium with a specific aim. For example, process water, in which contaminants have accumulated or concentrated, must be purified so that the process water can be reused or disposed of in an environmentally appropriate manner.

Methods known hitherto for processing a liquid medium, especially for removing substances from the liquid medium, have usually been based on a heat treatment in which thermal energy is fed to the medium via a heat exchanger. Such heat treatment is as a rule associated with high energy expenditure and subsequently also with high (energy) costs.

### SUMMARY OF INVENTION

An object of the invention is to disclose a method by means of which a liquid medium can be processed in a cost effective manner.

This object is achieved by means of a method of the type referred to in the introduction, in which according to the invention a liquid-steam separation is carried out in a separation device, and a liquid which is produced during the liquid-steam separation is introduced into the heat exchanger as heating medium.

The invention is based on the consideration that the liquid which is produced during the liquid-steam separation can have a high heat content, especially if it is produced from a fluid which is used as a heat-transfer medium and consequently has a high heat content.

By the liquid which is produced during the liquid-steam separation being introduced into the heat exchanger, thermal energy which is contained in the liquid can be used for heating the medium to be processed. In this way, the medium to be processed can be heated in an energy efficient manner. This in turn enables a reduction of the energy costs during processing of the medium. Furthermore, the effect of the thermal energy of the liquid being exhausted from a system, in which the medium is used, without being utilized, or being dissipated to the environment without being utilized, can be avoided.

The method is advantageously used in a steam turbine plant. In principle, the method can also be used in another plant or in another system.

The medium to be processed can for example be water or can have water as the main constituent. Moreover, the medium to be processed can contain organic and/or inorganic contaminants. The contaminants can exist in the medium to be processed especially in dissolved or suspended form.

The processing of the medium can inter alia comprise a removal of the contaminants from the medium. The processing of the medium can also comprise a production of a demineralized liquid from the medium to be processed.

For logical reasons, the medium to be processed is conducted through the heat exchanger. The heat exchanger is expediently designed as a liquid-to-liquid heat exchanger. That is to say, both a heat absorbing medium, which is conducted through the heat exchanger, and a heat yielding medium, which is conducted through the heat exchanger, is expediently a liquid in each case. The medium to be processed can absorb heat from the liquid which is produced during the liquid-steam separation. Vice versa, the latter can yield heat to the medium to be processed.

A contaminated liquid, especially blowdown water, from a steam drum is advantageously introduced into the separation device. As a result, it is possible to utilize thermal energy, which is contained in the contaminated liquid, for heating the medium to be processed. In this way, the effect of the contaminated liquid or the (residual) heat contained in the contaminated liquid being dissipated from a system, for example from a steam turbine cycle, without be utilized can be avoided.

During the liquid-steam separation, steam is expediently separated from the contaminated liquid, for example by expansion of the contaminated liquid in the separation device. The separated steam from the separation device is advantageously introduced into an element of a steam generator (also referred to as a steam boiler). For logical reasons, the steam generator is a component part of the previously mentioned steam turbine plant.

In the steam drum, a first pressure can prevail, whereas in the element of the steam generator, in which the steam is introduced, a second pressure can prevail. The second pressure is advantageously lower than the first pressure. This enables the steam to flow from the separation device into said element of the steam generator.

The liquid which is produced during the liquid-steam separation is expediently produced from the contaminated liquid. Furthermore, the liquid which is produced during the liquid-steam separation can be a liquid separated from the steam or which remains behind during the liquid-steam separation.

It is also expedient if the contaminated liquid—especially only when a blowdown of one or more steam drums is carried out—is introduced discontinuously into the separation device. Accordingly, the liquid-steam separation is expediently carried out discontinuously.

The element of the steam generator into which the separated steam from the separation device is introduced is advantageously an additional steam drum. Alternatively, the element of the steam generator into which the separated steam from the separation device is introduced can be an element of the steam generator connected downstream to the additional steam drum, such as a connecting line from the additional steam drum to a superheater.

The steam can be conducted from the additional steam drum or from the element connected downstream to the additional steam drum inter alia to a steam turbine of the steam turbine plant, for example in order to increase steam mass flow in the steam turbine and therefore to also increase output of the steam turbine plant.

The two previously mentioned steam drums are for logical reasons component parts of the steam generator.

In principle, the contaminated liquid from an optional first element of the steam generator can be introduced into the separation device. Moreover, the steam separated out during the liquid-steam separation can be directed into an optional second element of the steam generator, in which a lower pressure prevails than in the first element.

The liquid which is produced during the liquid-steam separation is advantageously conducted through the heat exchanger. In an advantageous development of the method, the liquid which is produced during the liquid-steam separation is introduced from the heat exchanger into the liquid circuit, especially into a buffer tank. The liquid which is produced during the liquid-steam separation can also form at least a part of the medium to be processed.

According to an advantageous embodiment of the method, a carrier medium, especially a gaseous carrier medium, such as air, is conducted through an evaporator and a condenser in a cooling circuit.

The condenser is advantageously designed as a liquid-to-gas heat exchanger. That is to say, a first medium which flows through the condenser is for logical reasons a liquid, and a second medium which flows through the condenser is for logical reasons a gas or a gas mixture.

Furthermore, the evaporator and the condenser can be regarded in each case as being both an element of the liquid circuit and as an element of the cooling circuit. For logical reasons, the medium to be processed is conducted through the condenser and the evaporator in the liquid circuit.

The medium to be processed is expediently dispersed in the evaporator, especially atomized. The medium to be processed can for example be dispersed in the evaporator, especially atomized, by means of an atomizing device. At least some of the dispersed medium to be processed advantageously evaporates and is picked up by the (gaseous) carrier medium. Also, the carrier medium can entrain drops which are formed during the dispersion or atomization of the medium to be processed. It is also advantageous if at least some of the evaporated medium to be processed, which is picked up by the carrier medium, condenses in the condenser.

The carrier medium in the evaporator advantageously absorbs heat from the dispersed medium to be processed. As a result, a saturation steam pressure of the medium to be processed can be increased in the carrier medium so that the carrier medium can absorb more steam. As a result of the heat yield to the carrier medium, the medium to be processed is advantageously cooled.

Furthermore, it is expedient if a condensate is produced in a condenser, especially in the previously mentioned condenser. For logical reasons, the condensate, which is produced in the condenser, is formed during the previously mentioned condensation during which the medium to be processed, which is picked up by the carrier medium, condenses in the condenser.

As a result of the previously described evaporation-condensation process, the effect of the condensate having a lower concentration of contaminants, compared with the medium to be processed originally introduced into the liquid circuit, can be achieved. Furthermore, the previously described evaporation-condensation process, compared with other processing methods, is distinguished by a low requirement for chemicals for processing the liquid medium.

It can be provided that the condensate is degassed. During this, dissolved gases which are contained in the condensate are expediently removed from said condensate. In this way, for example a process liquid for a steam turbine cycle can be produced. The condensate can especially be degassed with the aid of a degassing device, such as a membrane degasser.

It can also be provided that the degassed condensate is introduced into the steam turbine cycle and/or is deionized, especially with the aid of an electro-deionization module. During the deionization of the condensate, ions and/or ionizable substances which are contained in the condensate are expediently removed from said condensate. As a result of this, for example a demineralized liquid can be produced.

The medium to be processed is advantageously heated in the liquid circuit with the aid of an additional heat exchanger. As a result of this, additional heating of the medium to be processed can be achieved. Consequently, it is possible to reduce a mass flow through the first-mentioned heat exchanger without a lower heat feed into the liquid circuit having to be accepted as a consequence.

The additional heat exchanger can especially be a liquid-to-liquid heat exchanger. The additional heat exchanger is also arranged in the liquid circuit for logical reasons. At least some of a process liquid, which flows through a condensate preheater, is advantageously directed from the condensate preheater into the additional heat exchanger as heating medium. The condensate preheater is advantageously a component part of the previously mentioned steam turbine plant.

The medium to be processed advantageously absorbs heat from the process liquid. It is also advantageous if the process liquid is conducted from the additional heat exchanger back into the condensate preheater.

That part of the medium to be processed which discharges from an evaporator in liquid form, especially from the previously mentioned evaporator, is expediently cooled. An additional heat exchanger is advantageously used for this purpose. In this way, the previously mentioned condensation in the condenser is made easier. This additional heat exchanger is expediently a liquid-to-liquid heat exchanger. It is also advantageous if that part of the medium to be processed which discharges from the evaporator is introduced into a buffer tank, especially into the previously mentioned buffer tank.

Furthermore, it can be provided that an acid is introduced into the liquid circuit, especially into the evaporator. As a result, for example a forming of carbonates in the medium to be processed can be prevented or reduced.

Also, a liquid-steam separation can be carried out in an additional separation device. In the additional separation device, a lower pressure advantageously prevails than in the first-mentioned separation device. The pressure in the additional separation device can be for example atmospheric pressure or approximately atmospheric pressure. Moreover, it can be provided that steam and/or a liquid from the first-mentioned separation device is introduced into the additional separation device. It is also expedient if a liquid which is produced during the liquid-steam separation in the additional separation device is introduced into the liquid circuit, especially into the buffer tank. The last-mentioned liquid can form a part of the medium to be processed. In this way, the effect of the last-mentioned liquid being disposed of without being utilized can be avoided.

A residual liquid is advantageously discharged from the liquid circuit, especially into a cooling tower or into an (external) disposal device. That part of the medium to be processed which in the course of the processing procedure does not condense in the condenser or remains behind in the liquid circuit after the processing can be regarded as residual liquid in the present case. The residual liquid for logical reasons has a higher concentration of contaminants than the medium to be processed originally introduced into the liquid circuit.

It is also an object of the invention to provide a processing plant for processing a liquid medium, by means of which the medium can be processed in a cost effective manner.

This object is achieved by means of a processing plant of the type referred to in the introduction, which according to the invention has a separation device which is connected to the heat exchanger and in which a liquid-steam separation can be carried out, wherein a liquid which is produced during the liquid-steam separation can be introduced into the heat exchanger as heating medium.

The liquid circuit is expediently adapted to conduct the medium to be processed. It is also advantageous if the heat exchanger is connected on the inlet side to the separation device. The separation device can be designed as a separating tank, for example.

For logical reasons, the liquid circuit comprises a feed pump which is adapted to feed the medium to be processed in the liquid circuit. Furthermore, the processing plant can have a tank for storing the processed medium.

It is also advantageous if the processing plant comprises a cooling circuit. The cooling circuit can have inter alia a condenser. The cooling circuit can also have an evaporator.

The evaporator and the condenser can also be regarded as an element of the liquid circuit in each case. For logical reasons, the evaporator and the condenser can be exposed to throughflow of the medium to be processed.

The evaporator expediently comprises a tank. Furthermore, the evaporator can have an atomizing device for dispersing, especially for atomizing, the medium to be processed. For logical reasons, the atomizing device is arranged in the tank. Moreover, it is advantageous if the evaporator has a carrier-medium admission device for admitting a carrier medium, especially a gaseous carrier medium, into the tank.

Furthermore, a discharge pipe can be connected to the condenser and is provided for discharging a condensate from said condenser.

The evaporator can be designed as a counterflow evaporator. Moreover, the condenser can be designed as a counterflow condenser. That is to say, a heat absorbing medium and a heat yielding medium flow in the evaporator or condenser advantageously in directions opposite to each other.

Furthermore, the cooling circuit can have a fan. The fan is expediently adapted to feed a gaseous carrier medium from the condenser to the evaporator and from the evaporator back again to the condenser.

In an embodiment of the processing plant, the liquid circuit comprises a buffer tank. The first-mentioned heat exchanger is expediently connected on the outlet side to the buffer tank. The buffer tank can also be connected to a tank which contains a liquid which is to be demineralized, for example drinking water.

For logical reasons, the liquid circuit comprises a discharge pipe for discharging a residual liquid from the liquid circuit. The liquid circuit can also have a directional valve, especially a 3-way valve. The directional valve can be arranged for example between the evaporator and the buffer tank. The discharge pipe is advantageously connected to the directional valve.

In an advantageous development of the invention, the liquid circuit comprises an additional heat exchanger. The additional heat exchanger is expediently adapted to cool a liquid, especially a liquid which discharges from the evaporator. The liquid which discharges from the evaporator can especially be that part of the medium to be processed which is not previously condensed in the condenser.

The additional heat exchanger can for example be a component part of a closed cooling system. Alternatively, the additional heat exchanger can be a component part of a once-through cooling system. In the last-mentioned case, the additional heat exchanger can be connected to the buffer tank.

Furthermore, it is expedient if the processing plant is equipped with a degassing device, especially with a membrane degasser. For logical reasons, the degassing device is connected to the condenser.

It is also advantageous if the processing plant has an electro-deionization module, also called an EDI module. The electro-deionization module can especially be a so-called continuous electro-deionization module (CEDI module). The electro-deionization module is expediently connected to the degassing device. It is also practical if the electro-deionization module is connected downstream to the degassing device.

Arranged between the degassing device and the electro-deionization module can be a directional valve, especially a 3-way valve. Via the directional valve, a (degassed) liquid which discharges from the degassing device can be directed to the electro-deionization module and/or can be introduced into another element or another system, such as into a steam turbine cycle.

Furthermore, the processing plant can be a component part of a steam turbine plant. For logical reasons, the steam turbine plant comprises a steam turbine, advantageously a steam turbine with a plurality of pressure stages. It is also expedient if the steam turbine plant comprises a steam generator. The steam generator can in turn have a first steam drum in which a first pressure prevails. The steam generator can also have a second steam drum in which a second, lower pressure prevails. The separation device is advantageously connected to the first steam drum. It is also advantageous if the separation device is connected to the second steam drum. The separation device can especially be connected on the steam side to the first and/or to the second steam drum.

In addition to the two aforesaid steam drums, the steam generator can have one or more additional steam drums. The separation device can also be connected to one or more other elements of the steam generator, such as to a connecting pipe from a steam drum to a superheater of the steam generator.

It is also expedient if the steam turbine plant comprises a condensate preheater. The liquid circuit can also comprise an additional heat exchanger for heating the liquid to be processed. In an embodiment of the invention, the additional heat exchanger is connected to a condensate preheater, especially to the previously mentioned condensate preheater of the steam turbine plant. Consequently, it is possible to uncouple thermal energy from the condensate preheater for heating the medium to be processed. The additional heat exchanger is advantageously connected on the inlet side to an outlet of the condensate preheater. On the outlet side, the additional heat exchanger is advantageously connected to an inlet of the condensate preheater or to an element of the steam turbine cycle which is connected upstream to the condensate preheater.

The processing plant advantageously comprises an additional separation device in which a liquid-steam separation can be carried out. The additional separation device can be designed for example as a separating tank. Advantageously, lower pressure prevails in the additional separation device than in the first-mentioned separation device. In the additional separation device, for example atmospheric pressure or approximately atmospheric pressure can prevail. It is also expedient if the additional separation device is connected to the first-mentioned separation device. The additional separation device can also be connected to the buffer tank.

The method described further above is expediently used in the processing plant or in the steam turbine plant. Conversely, concrete elements which are used in the method can be component parts of the processing plant or of the steam turbine plant.

The processing plant can be used inter alia for producing or for recovering a process liquid for a steam turbine cycle. In the case of this application, the processing plant can be operated for example according to the above-described method.

The recovered/produced process liquid can be water, for example. The process liquid is expediently introduced into the steam turbine cycle. It is also expedient if the process liquid is evaporated in the steam generator. The thereby generated steam can be used to drive the steam turbine.

For logical reasons, the process liquid is produced from the medium to be processed. The medium to be processed can in turn be a contaminated process liquid from the steam turbine cycle in the case of this application.

As a result of said recovery/producing of the process liquid, consumption of the process liquid can be reduced during an operation of the steam turbine plant.

The processing plant can also be used for producing a demineralized liquid, especially for producing demineralized water.

In the case of the last-mentioned application of the processing plant, a liquid to be demineralized, e.g. drinking water, is expediently introduced into the liquid circuit, especially into the buffer tank. The liquid to be demineralized advantageously passes through the liquid circuit. In the case of this application of the processing plant, it is possible that the first-mentioned heat exchanger of the processing plant is operated as a flow conducting element without heating effect or without heat transfer of a heating medium. The liquid to be demineralized is advantageously heated with the aid of the additional heat exchanger of the processing plant.

Furthermore, it is expedient if the liquid to be demineralized evaporates in the evaporator and then condenses in the condenser. The condensed liquid to be demineralized can be degassed with the aid of the degassing device and deionized with the aid of the electro-deionization module. In this way, the demineralized liquid can be produced in an energy efficient manner.

The demineralized liquid can be introduced into the steam turbine cycle for example as additional liquid (make-up water), especially in order to counteract a concentration of contaminants in the process liquid or in the steam.

The previously provided description of advantageous embodiments of the invention contain many features which are reproduced in the individual dependent claims in a partially combined manner to form several others. These features, however, can expediently also be considered individually or be grouped to form practical additional combinations. These features can especially be combined individually in each case and in any suitable combination with the method according to the invention and with the processing plant according to the invention. Therefore, method features, concretely formulated, are also to be seen as being characteristics of the corresponding device unit, and vice versa.

Even if certain terms are used in the description or in the patent claims in the singular in each case or in conjunction with a numeral, the scope of the invention is not to be limited to the singular or to the respective numeral for these terms. Moreover, the indefinite article ‘a’ or ‘an’ should also not impose any restriction to the singular.

The above-described characteristics, features and advantages of the invention and also the way in which these are achieved become more clearly and distinctly comprehensible in conjunction with the following description of the exemplary embodiments of the invention which are explained in more detail in conjunction with the drawings. The exemplary embodiments serve for the explanation of the invention and do not limit the invention to the combinations of features disclosed therein, nor in regard to functional features. Furthermore, for this, suitable features of each one of the exemplary embodiments, considered in an explicitly isolated manner, can also be removed from one exemplary embodiment, be introduced into another exemplary embodiment for its supplementation and be combined with any other of the claims.

### BRIEF DESCRIPTION OF THE DRAWINGS

In the drawing:

FIG. 1 shows a steam turbine plant having a processing plant for processing a liquid medium; and

FIG. 2 shows a further steam turbine plant having a processing plant for processing a liquid medium.

### DETAILED DESCRIPTION OF INVENTION

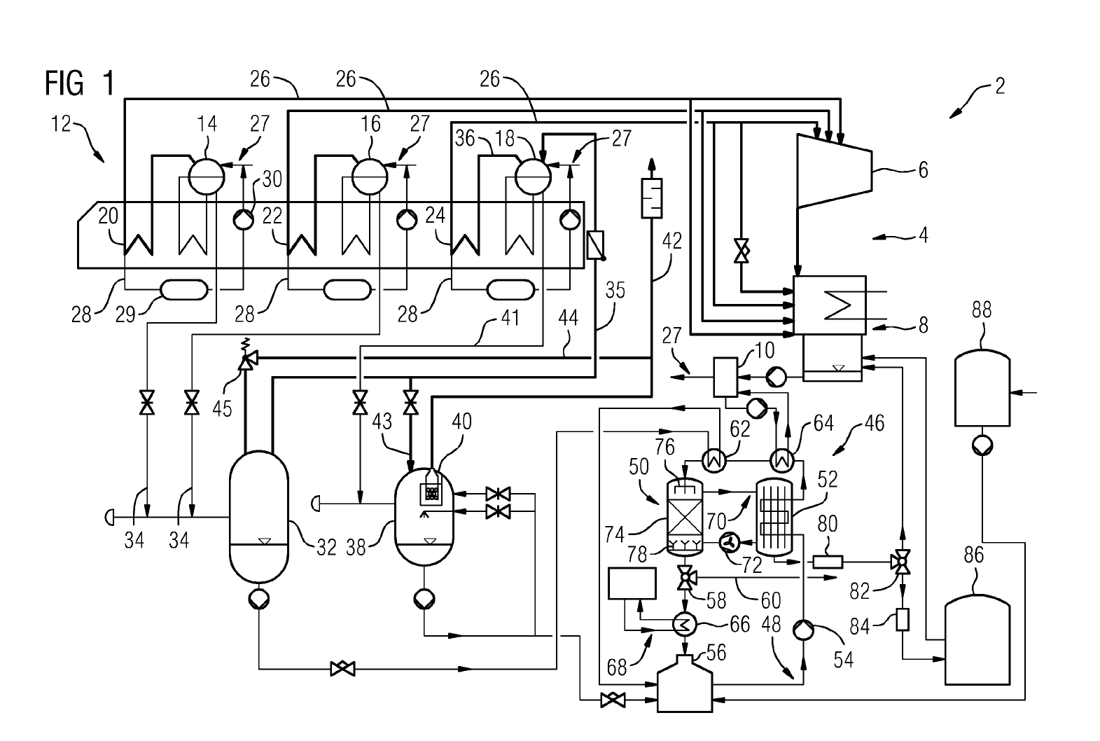

FIG. 1 shows a schematic, simplified view of a steam turbine plant 2. The steam turbine plant 2 has a steam turbine cycle 4. The steam turbine cycle 4 in turn comprises inter alia a three-stage steam turbine 6, a condenser unit 8 and also a steam generator 10.

The steam generator 10 comprises a condensate preheater 12, wherein the condensate preheater 12, for the sake of better illustration, is shown spatially separated from the other elements of the steam generator 10. The steam generator 10 also comprises a first steam drum 14, a second steam drum 16 and also a third steam drum 18. During operation of the steam turbine plant 2, a higher pressure prevails in the first steam drum 14 (high-pressure drum) than in the second steam drum 16 (intermediate-pressure drum), wherein in the second steam drum 16 higher pressure prevails in turn than in the third steam drum 18 (low-pressure drum).

The steam generator 10 also has a high-pressure superheater 20, an intermediate-pressure superheater 22 and a low-pressure superheater 24. The high-pressure superheater 20 is associated with the first steam drum 14. The intermediate-pressure superheater 22 is associated with the second steam drum 16 and the low-pressure superheater 24 is associated with the third steam drum 18 accordingly. The respective superheater 20, 22, 24 is connected to the steam drum 14, 16, 18 associated with it. Moreover, the superheaters 20, 22, 24 are connected in each case via a live steam pipe 26 to the steam turbine 6.

Furthermore, the steam turbine 6 is connected to the condenser unit 8. The condenser unit 8 is connected in turn to the condensate preheater 12. The condensate preheater 12 is also connected via a piping system 27 to the steam drums 14, 16, 18, wherein this piping system 27, for the sake of better clarity, is not shown in its entirety in FIG. 1.

Moreover, the steam generator 10 has three return pipes 28 which each comprise a temporary liquid storage tank 29 and a pump 30. Each of the three return pipes 28 is connected to one of the three superheaters 20, 22, 24 and also to the steam drum 14, 16, 18 which is associated with the respective superheater 20, 22, 24. The return pipes 28 are used for feeding a (process) liquid, which during operation of the steam turbine plant 2 makes its way out of the respective steam drum 14, 16, 18 into the associated superheater 20, 22, 24, back again into the corresponding steam drum 14, 16, 18.

Furthermore, the steam turbine plant 2 has a first separation device 32 which is designed as a separation tank and in which a liquid-steam separation can be carried out. The first separation device 32 is connected to the first and to the second steam drum 14, 16 respectively via a connecting pipe 34. The first separation device 32 is also connected via a further connecting pipe 35 to the third steam drum 18. Optionally, the first separation device 32 is connected to a connecting pipe 36 which connects the third steam drum 18 to the low-pressure superheater 24. For the sake of better clarity, the last-mentioned (optional) connection is not shown by way of a figure.

The steam turbine plant 2 also has a second separation device 38 which is designed as a separation tank and in which a liquid-steam separation can be carried out. The second separation device 38 comprises a cooling trap 40. Connected to the second separation device 38, especially to its cooling trap 40, is a steam discharge pipe 42 via which steam can be exhausted from the second separation device 38 into the atmosphere. Moreover, the second separation device 38 is connected via a connecting pipe 41 to the third steam drum 18.

The first separation device 32 is also connected to the second separation device 38 via a branch pipe 43 which branches from the additional connecting pipe 35. The first separation device 32 is also connected to the steam discharge pipe 42 via an additional connecting pipe 44 which features a safety valve 45. If a pressure in the first separation device 32 exceeds a predetermined maximum pressure, steam can be released via the additional connecting pipe 44 from the first separation device 32 into the atmosphere.

Furthermore, the steam turbine plant 2 is equipped with a processing plant 46 for processing a liquid medium. The processing plant 46 comprises a liquid circuit 48 with an evaporator 50, a condenser 52, a feed pump 54 and a buffer tank 56. Furthermore, the liquid circuit 48 comprises a first 3-way valve 58 which is arranged between the evaporator 50 and the buffer tank 56. Connected to this 3-way valve 58 is a disposal pipe 60.

The liquid circuit 48 also comprises a first heat exchanger 62, a second heat exchanger 64 and also a third heat exchanger 66. All three heat exchangers 62, 64, 66 are designed as liquid-to-liquid heat exchangers. The first heat exchanger 62 is connected on the inlet side to the first separation device 32 and on the outlet side connected to the buffer tank 56. The second heat exchanger 64 on the other hand is connected on the inlet side to an outlet of the condensate preheater 12 and on the outlet side connected to an inlet of the condensate preheater 12. The third heat exchanger 66 is also a component part of a closed cooling system 68.

Moreover, the previously mentioned elements of the liquid circuit 48 are interconnected via a system of pipes.

The processing plant 46 also comprises a cooling circuit 70 in which a gaseous carrier medium can circulate. The previously mentioned evaporator 50 and the condenser 52 are not only component parts of the liquid circuit 48 but also component parts of the cooling circuit 70. Moreover, the cooling circuit 70 comprises a fan 72 which is adapted to feed the gaseous carrier medium from the condenser 52 to the evaporator 50 and from the evaporator 50 back again to the condenser 52.

The evaporator 50 comprises a tank 74 and also an atomizing device 76 which is adapted to disperse or to atomize the medium to be processed in the tank 74. The evaporator 50 also has a carrier-medium admission device 78 which is adapted to admit the gaseous carrier medium into the tank 74 and to disperse it there. The evaporator 50 also has an inlet, not shown by way of a figure, which is provided for introducing an acid into the tank 74.

Moreover, the processing plant 46 has a degassing device 80, especially a membrane degasser. The degassing device 80 is connected on the inlet side to the condenser 52. On the outlet side, the degassing device 80 is connected via a second 3-way valve 82 to an electro-deionization module 84 which in its turn is connected on the outlet side to a first liquid tank 86. The second 3-way valve 82 is also connected to the condenser unit 8.

The processing plant 46 also comprises a second liquid tank 88 which contains a liquid to be demineralized, for example drinking water, and is connected to the buffer tank 56.

During operation of steam turbine plant 2, steam is generated in the steam generator 10 from a process liquid, in the present example from process water. The steam is directed via the live steam pipes 26 into the steam turbine 6 which is driven by the steam.

The steam from the steam turbine 6 is also directed into the condenser unit 8 in which the steam condenses. The condensate which is formed thereby is fed again to the steam generator 10 and the described process is cyclically repeated.

Furthermore, during operation of the steam turbine plant 2 contaminants are concentrated in the process liquid so that the steam drums 14, 16, 18 have to be blown down from time to time. For this purpose, the contaminated process liquid, in the present case therefore blowdown water, from the first and the second steam drum 14, 16 is introduced into the first separation device 32. From the third steam drum 18, the contaminated process liquid is introduced into the second separation device 38.

In the first separation device 32, a liquid-steam separation is carried out. During this, steam is separated from the contaminated process liquid by the contaminated process liquid being expanded in the first separation device 32. Some of the steam from the first separation device 32 is introduced via the additional connecting pipe 35 into the third steam drum. Optionally, some of the steam from the first separation device 32 is introduced into the connecting pipe 36 which connects the low-pressure superheater 24 to the third steam drum 18. From the third steam drum 18 or from the connecting pipe 36 the steam is further directed into the steam turbine 6. In this way, steam is recovered/produced from the contaminated process liquid for driving the steam turbine 6.

Furthermore, during the liquid-steam separation a liquid is produced. In the case of this liquid it is liquid which remains behind during the liquid-steam separation and which is produced from the contaminated process liquid. The liquid which is produced during the liquid-steam separation is introduced into the first heat exchanger 62 as heating medium and is conducted through said first heat exchanger 62. From the first heat exchanger 62, the liquid is introduced into the buffer tank 56, wherein it forms a part of a liquid medium which is to be processed.

In the second separation device 38, a liquid-steam separation is also carried out. During this, a liquid is produced in a similar manner. This liquid from the second separation device 38 is introduced directly into the buffer tank 56, wherein it forms another part of the medium to be processed. Steam which is produced during the liquid-steam separation in the second separation device 38 is released via the steam discharge pipe 42 into the atmosphere.

Also, a lower pressure prevails in the second separation device 38 than in the first separation device 32. Therefore, for example a pressure of several bar can prevail in the first separation device 32, whereas in the second separation device 38 for example atmospheric pressure, or approximately atmospheric pressure, can prevail.

The medium to be processed is heated in the liquid circuit 48 on the one hand with the aid of the first heat exchanger 62 and on the other hand with the aid of the second heat exchanger 64, wherein some of the process liquid, which flows through the condensate preheater 12, is introduced into the second heat exchanger 64 as heating medium. From the second heat exchanger 64, the process liquid is fed back again into the condensate preheater 12.

The medium to be processed, upon entering the evaporator 50, is also dispersed or atomized by means of the atomizing device 76 in the tank 74 of the evaporator 50. With the aid of the fan 72, air is conducted through the evaporator 50 as carrier medium against a flow direction along which the medium to be processed flows in the evaporator. Some of the dispersed medium to be processed evaporates in the tank 74, is picked up by the air and conducted by the air into the condenser 52.

Another part of the medium to be processed, which discharges from the evaporator 50 in liquid form—i.e. that part of the medium to be processed which is not evaporated and entrained by the air—is cooled by means of the third heat exchanger 66 and then introduced into the buffer tank 56.

Furthermore, it is provided that in the evaporator 50 an acid is introduced into the liquid circuit 48 so that a forming of carbonates in the medium to be processed is prevented or reduced.

With the aid of the feed pump 54, the part of the medium to be processed which is introduced into the buffer tank 56 is fed from the buffer tank 56 to the condenser 52. When flow passes through the condenser 52, this part of the medium to be processed cools the evaporated part of the medium to be processed which is picked up by the carrier medium. Consequently, in the condenser 52 a condensate is produced from the medium to be processed.

The condensate is directed into the degassing device 80 and degassed with the aid of said degassing device 80. The condensate can also be introduced via the second 3-way valve 82 directly into the steam turbine cycle 4, for example into the condenser unit 8, and used as process liquid for the steam turbine cycle 4. Alternatively, the condensate can be deionized after its degassing initially with the aid of the electro-deionization module 84 in order to produce a demineralized liquid (demineralized water) from the condensate. The demineralized liquid can be stored in the first tank 86 and when required can be introduced into the steam turbine cycle 4 as additional liquid (make-up water).

A residual liquid, which remains behind in the liquid circuit 48 during or after the processing of the medium, can be discharged via the disposal pipe 60 from the liquid circuit 48, for example to a cooling tower or to an external disposal device.

The above-described method makes it possible to reduce a waste water or dirty water emergence of the steam turbine plant 2. The above-described method also enables an energy-efficient operation of the steam turbine plant 2, especially because thermal energy, which is contained in the contaminated process liquid, can be used to a great extent for processing said contaminated process liquid.

Furthermore, the processing plant 46 can also be used in another way, which does not have to be coupled to the blowdown of the steam drums 14, 16, 18, for producing a demineralized liquid. The liquid to be demineralized, which is contained in the second tank 88, can be introduced from the second tank 88 into the buffer tank 56. The liquid to be demineralized can then pass through the liquid circuit 48 corresponding to the above-described manner. With this, it is not necessary, however, that a heating medium is introduced into the first heat exchanger 62. That is to say, the first heat exchanger 62 can be used to conduct the liquid to be demineralized in the liquid circuit 48 but without heating it.

The following description is limited in the main to the differences to the preceding exemplary embodiment described in conjunction with FIG. 1, to which reference is made with regard to consistent features and functions. In the main, the same elements, or elements corresponding to each other, are basically identified by the same designations and mentioned features are not assumed in the following exemplary embodiment without them being described anew.

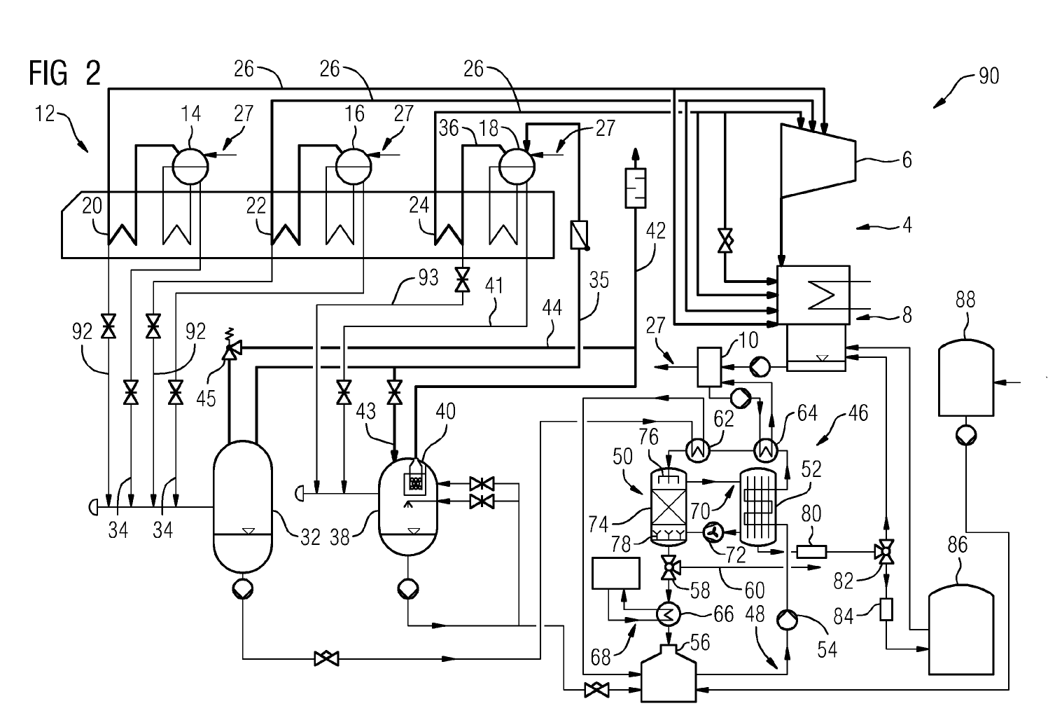

FIG. 2 shows a schematic, simplified view of a further steam turbine plant 90.

The further steam turbine plant 90 differs from the steam turbine plant 2 from FIG. 1 inter alia by the fact that it has no return pipes from the superheaters 20, 22, 24 to the steam drums 14, 14, 18. Instead, the further steam turbine plant 90 has two additional connecting pipes 92 via which the high-pressure superheater 20 and the intermediate-pressure superheater 22 are connected in each case to the first separation device 32. Moreover, the further steam turbine plant 90 has an additional connecting pipe 93 via which the low-pressure superheater 24 is connected to the second separation device 38.

In the case of the present exemplary embodiment, the contaminated process liquid from the first two steam drums 14, 16 and also from the high-pressure superheater 20 and the intermediate-pressure superheater 22 is introduced into the first separation device 32. The contaminated process liquid from the third steam drum 18 and from the low-pressure superheater 24 is also introduced into the first separation device 32.

As in the preceding exemplary embodiment, the liquid medium to be processed also consists in this exemplary embodiment of the liquids which are produced during a liquid-steam separation in the first separation device 32 and also during a liquid-steam separation in the second separation device 38 and which are introduced into the liquid circuit 48. In the liquid circuit 48, the medium to be processed is processed corresponding to the manner described further above in conjunction with FIG. 1.

Although the invention has been fully illustrated and described in detail by means of the preferred exemplary embodiments, the invention is not limited by the disclosed examples and other variations can be derived therefrom by the person skilled in the art without departing from the scope of protection of the invention.

1.-15. (canceled)

16. A method for processing a liquid medium, the method comprising:
conducting the medium to be processed through a liquid circuit,
heating the medium to be processed in the liquid circuit with the aid of a heat exchanger, carrying out a liquid-steam separation in a separation device,
introducing a liquid which is produced during the liquid-steam separation into the heat exchanger as heating medium,
conducting a gaseous carrier medium through an evaporator and a condenser in a cooling circuit,
dispersing the medium to be processed in the evaporator by an atomizing device, wherein at least some of the dispersed medium to be processed is evaporated and picked up by the gaseous carrier medium, and
condensing at least some of the evaporated medium to be processed, which is picked up by the carrier medium, in the condenser.

17. The method as claimed in claim 16, further comprising:
introducing a contaminated liquid from a steam drum in which a first pressure prevails into the separation device, wherein steam is separated from the contaminated liquid during the liquid-steam separation, and
introducing the separated steam from the separation device into an element of a steam generator, wherein a second pressure, which is lower than the first pressure, prevails in the element, and the liquid which is produced during the liquid-steam separation is produced from the contaminated liquid.

18. The method as claimed in claim 17,
wherein the element of the steam generator, into which the separated steam from the separation device is introduced, is an additional steam drum or an element of the steam generator which is connected downstream to the additional steam drum.

19. The method as claimed in claim 16,
wherein the liquid which is produced during the liquid-steam separation is conducted through the heat exchanger and from the heat exchanger is introduced into the liquid circuit,
wherein the liquid which is produced during the liquid-steam separation forms at least one part of the medium to be processed.

20. The method as claimed in claim 16,
wherein a condensate is produced in a condenser, which condensate is degassed with the aid of a degassing device, and the degassed condensate is introduced into a steam turbine cycle and/or is deionized with the aid of an electro-deionization module.

21. The method as claimed in claim 16,
wherein the medium to be processed is heated in the liquid circuit with the aid of an additional heat exchanger,
wherein at least some of a process liquid, which flows through a condensate preheater, is directed from the condensate preheater into the additional heat exchanger as heating medium.

22. The method as claimed in claim 16,
wherein that part of the medium to be processed which discharges from an evaporator in liquid form is cooled by an additional heat exchanger and is introduced into a buffer tank.

23. A processing plant for processing a liquid medium, comprising:
a liquid circuit with a heat exchanger for heating the medium to be processed,
a separation device, connected to the heat exchanger, adapted to carry out a liquid-steam separation, wherein a liquid which is produced during the liquid-steam separation is introduced into the heat exchanger as heating medium,
a cooling circuit, which is designed with a condenser and an evaporator, the cooling circuit adapted to feed a gaseous carrier medium from the condenser to the evaporator and from the evaporator back again to the condenser, and
an atomizing device, wherein the medium to be processed is dispersed in the evaporator by the atomizing device so that at least some of the dispersed medium to be processed evaporates and is picked up by the gaseous carrier medium and at least some of the evaporated medium to be processed, which is picked up by the carrier medium, is condensed in the condenser.

24. The processing plant as claimed in claim 23,
wherein the liquid circuit comprises an additional heat exchanger which is adapted to cool a liquid.

25. The processing plant as claimed claim 23, further comprising:
a degassing device and an electro-deionization module which is connected to the degassing device.

26. A steam turbine plant, comprising:
a processing plant as claimed in claim 23,
a steam generator with a first steam drum in which a first pressure prevails, and a second steam drum in which a second, lower pressure prevails,
wherein the separation device is connected to the first steam drum and to the second steam drum.

27. The steam turbine plant as claimed in claim 26, further comprising:
a condensate preheater, wherein the liquid circuit comprises an additional heat exchanger for heating the medium to be processed and which is connected to the condensate preheater.

28. A method for processing a liquid medium, the method comprising:
producing a process liquid for a steam turbine cycle and/or producing a demineralized liquid using the processing plant of claim 23.

29. The method as claimed in claim 16,
wherein the gaseous carrier medium comprises air.

30. The method as claimed in claim 17,
wherein the contaminated liquid comprises blowdown water.

31. The method as claimed in claim 19,
wherein the liquid which is produced during the liquid-steam separation is conducted through the heat exchanger and from the heat exchanger is introduced into a buffer tank.
